(19) United States
(12) Patent Application Publication
(10) Pub. No.: US 2015/0042690 A1
(43) Pub. Date: Feb. 12, 2015

(54) ORGANIC LIGHT EMITTING DIODE DISPLAY AND MANUFACTURING METHOD THEREOF

(71) Applicant: Samsung Display Co., Ltd., Yongin-City (KR)

(72) Inventors: Guang-Hai JIN, Yongin-City (KR); Jae-Beom CHOI, Yongin-City (KR); Kwan-Wook JUNG, Yongin-City (KR)

(73) Assignee: Samsung Display Co., Ltd., Yongin-City (KR)

(21) Appl. No.: 14/291,409

(22) Filed: May 30, 2014

(30) Foreign Application Priority Data
Aug. 6, 2013 (KR) 10-2013-0093178

(51) Int. Cl. G09G 3/32

(52) U.S. Cl. CPC G09G 3/3208; G09G 2300/0426
USPC 345/690; 345/82

(57) ABSTRACT

An organic light emitting diode display includes a substrate, a semiconductor layer disposed on the substrate and including an intrinsic poly-semiconductor part and a doped poly-semiconductor part, a gate insulating layer covering the semiconductor layer, a scan line disposed on the gate insulating layer and transmitting a scan signal, a data line insulated from and intersecting the scan line and transmitting a data signal, a thin film transistor connected to the scan line and the data line, and an organic light emitting diode connected to the thin film transistor, where the intrinsic poly-semiconductor part is positioned at a region near the scan line.

This application claims priority to Korean Patent Application No. 10-2013-0093178 filed on Aug. 6, 2013, and all the benefits accruing therefrom under 35 U.S.C. §119, the entire contents of which are incorporated herein by reference.

### BACKGROUND

(a) Field

The invention relates to an organic light emitting diode (“OLED”) display and a manufacturing method thereof.

(b) Description of the Related Art

An organic light emitting diode (“OLED”) display includes two electrodes and an organic light emitting member disposed therebetween. Electrons injected from one electrode and holes injected from the other electrode are combined in the organic light emitting member to form excitons, and light is emitted as the excitons release energy.

To minimize a number of masks used in a manufacturing method of the OLED display, an active pattern skip (“APS”) method has been developed, and the APS method is a method of manufacturing the OLED display in which the semiconductor layer is not etched but is maintained on an entire surface, and thereby the mask is not used when forming the semiconductor layer such that a number of masks may be effectively reduced.

### SUMMARY

In an active pattern skip (“APS”) method, a scan line extending in a predetermined direction overlaps an underlying semiconductor such that parasitic capacitance is generated such that a resistive-capacitive (“RC”) delay may be increased.

The invention provides an organic light emitting diode (“OLED”) display with reduced RC delay by minimizing parasitic capacitance between a scan line and a semiconductor layer, and a manufacturing method thereof.

An organic OLED display according to an exemplary embodiment includes a substrate, a semiconductor layer disposed on the substrate and including an intrinsic poly-semiconductor part and a doped poly-semiconductor part, a gate insulating layer covering the semiconductor layer, a scan line which is disposed on the gate insulating layer and transmits a scan signal, a data line which is insulated from and intersecting the scan line and transmits a data signal, a thin film transistor (“TFT”) connected to the scan line and the data line, and an organic OLED connected to the TFT, where the intrinsic poly-semiconductor part is positioned at a region near the scan line.

In an exemplary embodiment, the scan line may include a main scan line disposed on the gate insulating layer, and an assistance scan line disposed on the main scan line and contacting the main scan line.

In an exemplary embodiment, the data line may include an assistance data line disposed on the gate insulating layer, and a main data line disposed on the assistance data line and contacting the assistance data line.

In an exemplary embodiment, the doped poly-semiconductor part may include a crossing semiconductor part disposed at a crossing region of the scan line and the data line, and the crossing semiconductor part may include a first crossing semiconductor part and a second crossing semiconductor part separated from and facing each other.

In an exemplary embodiment, a crossing interlayer insulating layer pattern disposed on the crossing semiconductor part and the main scan line may be further included, and the crossing interlayer insulating layer pattern may insulate the main scan line and the main data line from each other.

In an exemplary embodiment, the crossing interlayer insulating layer pattern may have a cross shape that includes a transverse part and a longitudinal part that are crossed, the transverse part may contact the main scan line and is disposed thereon, and the longitudinal part may overlap the crossing semiconductor part.

In an exemplary embodiment, separated portions of the assistance scan line may be connected through the main scan line at the crossing region, and separated portions of the assistance data line may be connected through the main data line at the crossing region.

In an exemplary embodiment, the intrinsic poly-semiconductor part may be positioned under the main scan line and the assistance data line.

In an exemplary embodiment, the doped poly-semiconductor part may further include a transistor semiconductor part disposed at the TFT, and the transistor semiconductor part may include a source region and a drain region separated from and facing each other.

In an exemplary embodiment, a transistor interlayer insulating layer pattern partially overlapping the transistor semiconductor part, and a source electrode and a drain electrode partially overlapping the transistor semiconductor part, may be further included.

In an exemplary embodiment, a manufacturing method of an OLED display according to an exemplary embodiment includes sequentially forming a semiconductor layer including an intrinsic poly-semiconductor, a gate insulating layer, and a gate layer on a substrate, doping the semiconductor layer to provide a doped poly-semiconductor part and an intrinsic poly-semiconductor part, forming an interlayer insulating layer pattern on the doped poly-semiconductor part and the gate layer, forming a data layer on the gate layer and the interlayer insulating layer pattern, patterning the data layer to provide an assistance scan line and a main data line, and patterning the gate layer disposed at a region near the assistance scan line and the main data line to expose the intrinsic poly-semiconductor part.

In an exemplary embodiment, the doped poly-semiconductor part may include a crossing semiconductor part disposed at a crossing region of the assistance scan line and the main data line.

In an exemplary embodiment, the interlayer insulating layer pattern may include a crossing interlayer insulating layer pattern disposed at the crossing region.

In an exemplary embodiment, the crossing semiconductor part and the intrinsic poly-semiconductor part may be disposed by patterning the gate layer to define a gate opening and doping the semiconductor layer through the gate opening.

In an exemplary embodiment, a main scan line may be disposed under the assistance scan line and an assistance data line may be disposed under the main data line.

In an exemplary embodiment, forming a scan line including the main scan line and the assistance scan line, and a data line including the main data line and the assistance data line, and connecting a TFT to the scan line and the data line may be further provided.

In an exemplary embodiment, forming an OLED connected to the TFT may be further included.

According to an exemplary embodiment, by positioning the intrinsic poly-semiconductor part at the region near the scan line, generation of parasitic capacitance between the scan line and the semiconductor layer may be minimized, thereby reducing RC delay.

Further, by forming the interlayer insulating layer pattern at the crossing region of the scan line and the data line, the scan line and the data line may be insulated and crossed.

Also, the scan line includes the dual wire of the main gate line of the gate wire and the assistance gate line of the data wire and the data line includes the dual wire of the main data line of the data wire and the assistance data line of the gate wire such that a wire resistance of the scan line and the data line may be effectively reduced.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 shows an exemplary embodiment of an equivalent circuit of an organic light emitting diode (“OLED”) display according to the invention.

FIG. 2 is a plan view of an exemplary embodiment of one pixel of an OLED display according to the invention.

FIG. 3 is a cross-sectional view taken along line III-III of FIG. 2.

FIG. 4 is a cross-sectional view taken along line IV-IV of FIG. 2.

FIG. 5 is a cross-sectional view taken along lines V-V′ and V′-V″ of FIG. 2.

FIG. 6 is a cross-sectional view of a thin film transistor taken along line VI-VI of FIG. 2.

FIG. 7 is a cross-sectional view of a storage capacitor taken along line VII-VII of FIG. 2.

FIGS. 8 to 10 are plan views sequentially showing an exemplary embodiment of a manufacturing method of an OLED display according to the invention.

### DETAILED DESCRIPTION

The invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the invention.

In order to clarify a description of the invention, parts not related to the description are omitted, and the same reference numbers are used throughout the drawings to refer to the same or like parts.

Further, since sizes and thicknesses of constituent members shown in the accompanying drawings are arbitrarily given for better understanding and ease of description, the invention is not limited to the illustrated sizes and thicknesses.

In the drawings, the thickness of layers, films, panels, regions, etc., are exaggerated for clarity. In the drawings, for better understanding and ease of description, the thicknesses of some layers and areas are exaggerated. It will be understood that when an element such as a layer, film, region, or substrate is referred to as being “on” another element, it can be directly on the other element or intervening elements may also be present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

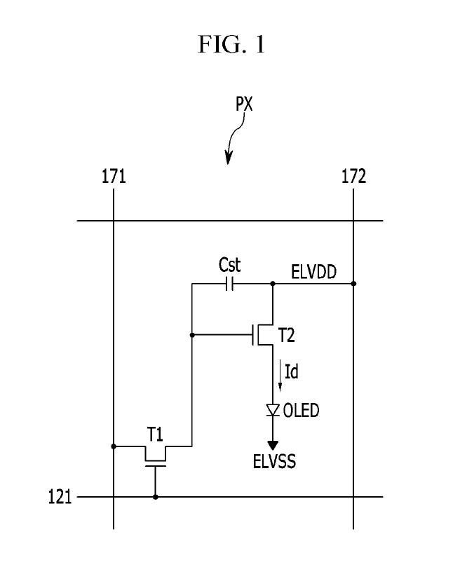

Next, an organic light emitting diode (“OLED”) display according to an exemplary embodiment will be described with reference to FIGS. 1 to 7.

FIG. 1 is an equivalent circuit of an OLED display according to an exemplary embodiment.

As shown in FIG. 1, an OLED display according to an exemplary embodiment includes a plurality of signal lines 121, 171, and 172, and a plurality of pixels PX connected thereto and arranged in an approximate matrix form.

The signal lines include a plurality of scan lines 121 for transmitting scan signals (or gate signals), a plurality of data lines 171 for transmitting data signals, and a plurality of driving voltage lines 172 for transmitting a driving voltage ELVDD. The scan lines 121 run parallel with each other in a row direction, and the data lines 171 and the driving voltage lines 172 run parallel with each other in a column direction. Each pixel PX includes a switching thin film transistor (“TFT”) T1, a driving TFT T2, a storage capacitor Cst and an OLED.

The switching TFT T1 has a control terminal, an input terminal and an output terminal. The control terminal is connected to the scan line 121, the input terminal is connected to the data line 171, and the output terminal is connected to the driving TFT T2. The switching TFT T1 transmits a data signal applied to the data line 171 to the driving TFT T2 in response to a scan signal applied to the scan lines 121.

The driving TFT T2 also has a control terminal, an input terminal, and an output terminal. The control terminal is connected to the switching TFT T1, the input terminal is connected to the driving voltage line 172, and the output terminal is connected to the OLED. The driving TFT T2 causes output current Id to flow, which varies in amplitude in accordance with a voltage applied between the control terminal and the output terminal thereof.

The storage capacitor Cst is connected between the control terminal and input terminal of the driving TFT T2. The storage capacitor Cst charges a data signal applied to the control terminal of the driving TFT T2, and maintains the data signal after the switching TFT T1 is turned off.

The OLED has an anode connected to the output terminal of the driving TFT T2 and a cathode connected to a common voltage ELVSS. The OLED displays an image by emitting light with different intensities according to an output current Id of the driving TFT T2.

The switching TFT T1 and the driving TFT T2 may be n-channel field effect transistors (“FETs”) or p-channel FETs. In another exemplary embodiment, the connection relationship among the thin film transistors T1 and T2, the storage capacitor Cst, and the OLED may vary.

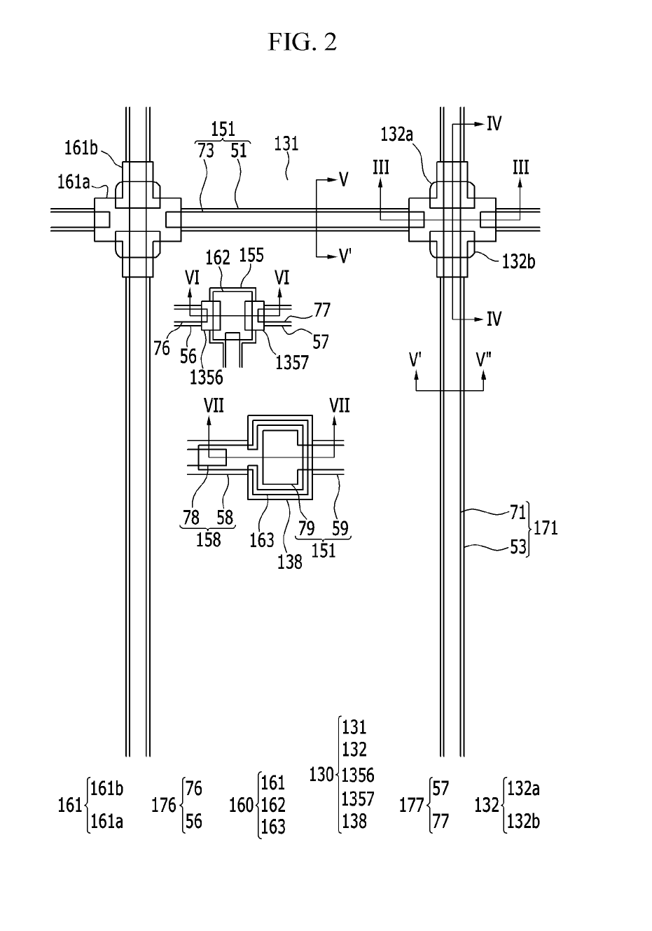

Next, a detailed structure of the pixel PX of the OLED display shown in FIG. 1 will be described with reference to FIGS. 2 to 7 as well as FIG. 1.

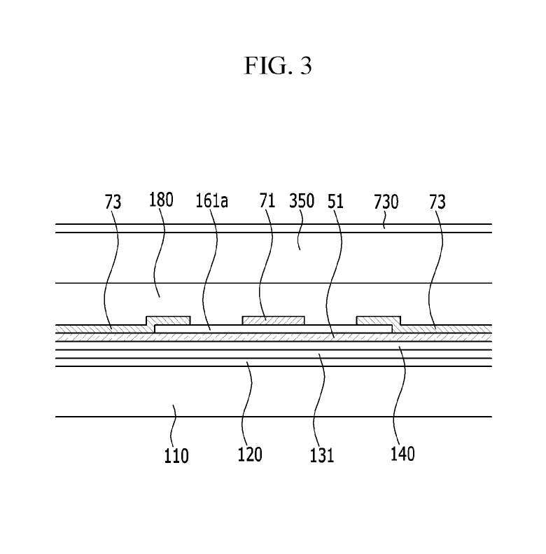

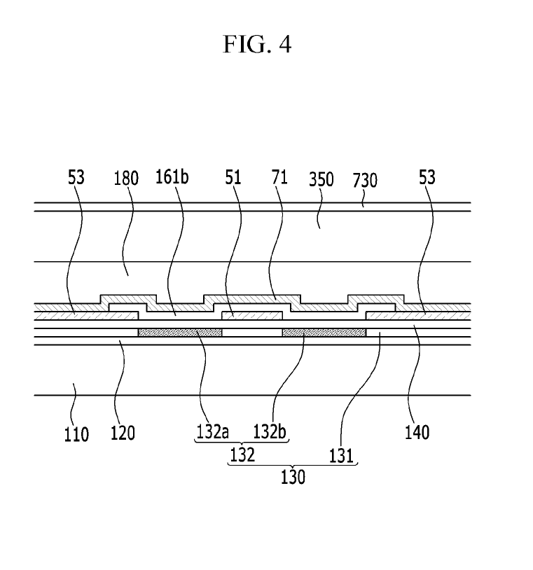

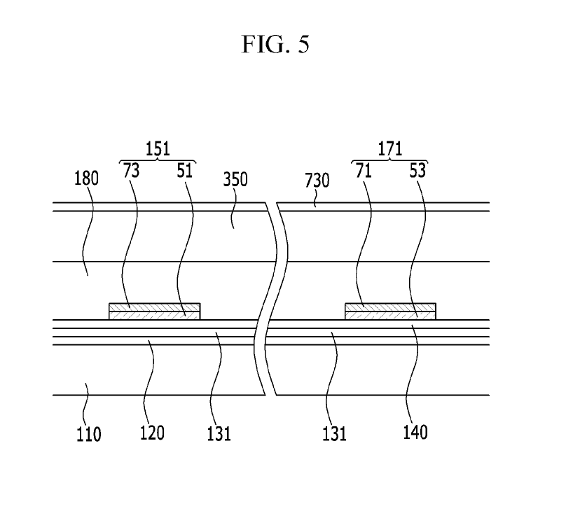

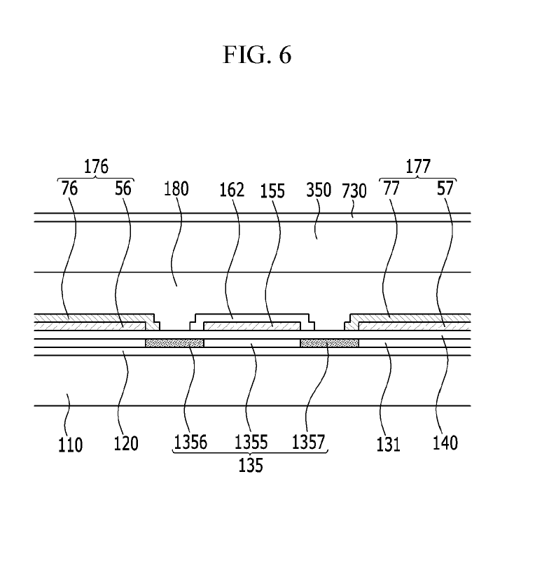

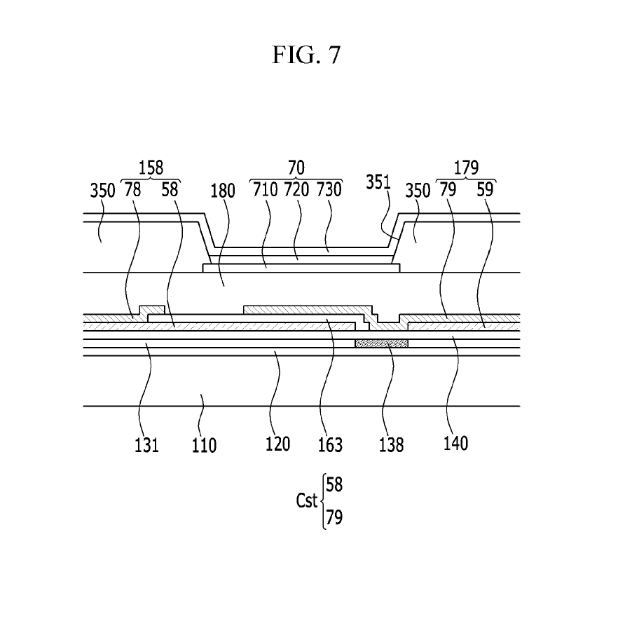

FIG. 2 is a plan view of one pixel of an OLED display according to an exemplary embodiment, FIG. 3 is a cross-sectional view taken along line III-III of FIG. 2, FIG. 4 is a cross-sectional view taken along line IV-IV of FIG. 2, FIG. 5 is a cross-sectional view taken along lines V-V′ and V′-V″ of FIG. 2, FIG. 6 is a cross-sectional view of a TFT taken along line VI-VI of FIG. 2, and FIG. 7 is a cross-sectional view of a storage capacitor taken along line VII-VII of FIG. 2.

As shown in FIGS. 2 to 7, in an OLED display according to an exemplary embodiment, a buffer layer 120 is disposed on a substrate 110. The substrate 110 may include an insulating substrate including glass, quartz, ceramic, or plastic, or may include a metallic substrate including stainless steel. The buffer layer 120 may have a single-layered structure including a silicon nitride (SiNx), or a double-layered structure including a silicon nitride (SiNx) and silicon dioxide (SiO2). The buffer layer 120 effectively prevents unwanted components like impure elements or moisture from intruding into a target, while flattening the surface thereof at the same time.

A semiconductor layer 130 including an intrinsic poly-semiconductor part 131 and doped poly-semiconductor parts 132, 1356, 1357 and 138 is disposed on the buffer layer 120. The intrinsic poly-semiconductor part 131 includes a region including an intrinsic poly-semiconductor in which an impurity is not doped, and the doped poly-semiconductor parts 132, 1356, 1357 and 138 are region doped with an impurity.

The intrinsic poly-semiconductor part 131 includes a region where the doped poly-semiconductor parts 132, 1356, 1357 and 138 are not provided, and the doped poly-semiconductor parts 132, 1356, 1357 and 138 include a crossing semiconductor part 132, transistor semiconductor parts 1356 and 1357, and a capacitor semiconductor part 138.

The crossing semiconductor part 132 is provided at a crossing region of a scan line 151 and a data line 171, and includes a first crossing semiconductor part 132a and a second crossing semiconductor part 132b that are separated from each other and face each other.

The transistor semiconductor parts 1356 and 1357 include a source region 1356 and a drain region 1357 provided at respective sides of a channel region 1355 of the intrinsic poly-semiconductor.

The capacitor semiconductor part 138 is provided in an approximately quadrangular ring shape.

A gate insulating layer 140 is disposed on the semiconductor layer 130 (refers to FIG. 4). The gate insulating film 140 may include a single layer or a plurality of layers including at least one of a silicon nitride and a silicon oxide.

A main scan line 51, an assistance data line 53, a gate electrode 155, an assistance source electrode 56, an assistance drain electrode 57, a first main storage capacitive plate 58, and a second assistance storage capacitive plate 59 are disposed on the gate insulating layer 140 (refers to FIGS. 2 to 7). The main scan line 51 extends in a transverse direction and transmits a scan signal, the assistance data line 53 extends in a longitudinal direction and transmits a data signal, the gate electrode 155 is connected to the main scan line 51 and overlaps the channel region 1355, and the first main storage capacitive plate 58 and the second assistance storage capacitive plate 59 are separated from each other. The main scan line 51, the assistance data line 53, the gate electrode 155, the assistance source electrode 56, the assistance drain electrode 57, the first main storage capacitive plate 58, and the second assistance storage capacitive plate 59 include a gate wire.

An interlayer insulating layer pattern 160 is disposed on the main scan line 51, the assistance data line 53, the gate electrode 155, the assistance source electrode 56, the assistance drain electrode 57, the first main storage capacitive plate 58, and the second assistance storage capacitive plate 59, and the interlayer insulating layer pattern 160 includes a crossing interlayer insulating layer pattern 161, a transistor interlayer insulating layer pattern 162, and a storage interlayer insulating layer pattern 163.

The crossing interlayer insulating layer pattern 161 is disposed on the main scan line 51 and the assistance data line 53 (refers to FIGS. 3 and 4), the transistor interlayer insulating layer pattern 162 is disposed on the gate electrode 155 (refers to FIG. 6), and the storage interlayer insulating layer pattern 163 is disposed on the first main storage capacitive plate 58 (refers to FIG. 7).

The crossing interlayer insulating layer pattern 161 has a cross shape in which a transverse part 161a and a longitudinal part 161b cross each other (refers to FIG. 2), the transverse part 161a contacts the main scan line 51 and is disposed on the main scan line 51 (refers to FIG. 3), and the longitudinal part 161b covers a portion of the main scan line 51 and a portion of an end of the assistance data line 53 and overlaps the crossing semiconductor part 132 (refers to FIG. 4).

The transistor interlayer insulating layer pattern 162 covers the gate electrode 155 and partially overlaps the transistor semiconductor parts 1356 and 1357 (refers to FIG. 6).

The storage interlayer insulating layer pattern 163 is provided within the capacitor semiconductor part 138 of the quadrangular ring shape and covers the first main storage capacitive plate 58.

In an exemplary embodiment, the interlayer insulating layer pattern 160 may include a silicon nitride or a silicon oxide as the gate insulating layer 140.

A data wire including a main data line 71, an assistance scan line 73, a main source electrode 76, a main drain electrode 77, a first assistance storage capacitive plate 78 and a second main storage capacitive plate 79 is disposed on the interlayer insulating layer pattern 160 and the gate wire including the main scan line 51, the assistance data line 53, the gate electrode 155, the assistance source electrode 56, the assistance drain electrode 57, the first main storage capacitive plate 58 and the second assistance storage capacitive plate 59.

The main data line 71 and the assistance scan line 73 are disposed on the crossing interlayer insulating layer pattern 161. The assistance scan line 73 is divided with reference to the main data line 71 disposed on the transverse part 161a of the crossing interlayer insulating layer pattern 161, and the divided assistance scan line 73 is connected through the main scan line 51.

The main data line 71 covers the longitudinal part 161b of the crossing interlayer insulating layer pattern 161, and connects the assistance data line 53 divided with reference to the main scan line 51 under the longitudinal part 161b of the crossing interlayer insulating layer pattern 161.

As described, the main scan line 51 and the assistance scan line 73 directly contact in the region where the transverse part 161a of the crossing interlayer insulating layer pattern 161 is not provided (refers to FIG. 3) thereby forming the scan line 151 such that a wire resistance of the scan line 151 may be reduced, and the main data line 71 and the assistance data line 53 directly contact in the region where the longitudinal part 161b of the crossing interlayer insulating layer pattern 161 is not provided (refers to FIG. 4) thereby forming the data line 171 such that the wire resistance of the data line 171 may be reduced.

Also, as shown in FIG. 5, the intrinsic poly-semiconductor part 131 is positioned at the region close to the scan line 151 such that generation of a parasitic capacitance between the scan line 151 and the semiconductor layer 130 is minimized thereby reducing RC delay.

Also, as shown in FIGS. 2 to 4, by forming the crossing interlayer insulating layer pattern 161 at the crossing region of the scan line 151 and the data line 171, the scan line 151 and the data line 171 are insulated from and cross each other.

The main source electrode 76 and the main drain electrode 77 are respectively disposed on the assistance source electrode 56 and the assistance drain electrode 57. The main source electrode 76 and the assistance source electrode 56 together provide a source electrode 176, and the main drain electrode 77 and the assistance drain electrode 57 together provide a drain electrode 177.

The transistor semiconductor parts 1356 and 1357, the gate electrode 155, the source electrode 176, and the drain electrode 177 together provide a driving thin film transistor.

The first assistance storage capacitive plate 78 is disposed on the first main storage capacitive plate 58, and the second main storage capacitive plate 79 is disposed on the second assistance storage capacitive plate 59. The first main storage capacitive plate 58 and the first assistance storage capacitive plate 78 together provide a first storage capacitive plate 158, and the second assistance storage capacitive plate 59 and the second main storage capacitive plate 79 together provide a second storage capacitive plate 179.

The first main storage capacitive plate 58 and the second main storage capacitive plate 79 provide a storage capacitor Cst having the storage interlayer insulating layer pattern 163 as a dielectric material.

A protective layer 180 is disposed on the main data line 71, the assistance scan line 73, the main source electrode 76, the main drain electrode 77, the first assistance storage capacitive plate 78, and the second main storage capacitive plate 79. A pixel electrode 710 is disposed on the protective layer 180. The pixel electrode 710 is electrically connected to a drain electrode 177 of the driving TFT T2 thereby being the anode of the OLED.

A pixel defining layer 350 is disposed on edge portions of the pixel electrode 710 and the protective film 180. An opening 351 exposing the pixel electrode 710 is defined in the pixel defining layer 350. The protective film 180 may include a resin such as a polyacrylate resin or a polyimide resin, a silica-based inorganic material, or the like.

An organic emission layer 720 is provided in the opening 351 of the pixel defining layer 350. The organic emission layer 720 is provided as a plurality of layers including one or more of an emission layer, a hole-injection layer (“HIL”), a hole-transporting layer (“HTL”), an electron-transporting layer (“ETL”) and an electron-injection layer (“EIL”). When the organic emission layer 720 includes all of them, the hole-injection layer may be positioned on the pixel electrode 710 serving as an anode, and the hole-transporting layer, the emission layer, the electron-transporting layer, and the electron-injection layer may be sequentially laminated on the pixel electrode 710.

The organic emission layer 720 may include a red organic emission layer for emitting red light, a green organic emission layer for emitting green light, and a blue organic emission layer for emitting blue light, and the red organic emission layer, the green organic emission layer, and the blue organic emission layer are respectively provided in red, green, and blue pixels, thereby displaying a color image.

Moreover, the red organic emission layer, green organic emission layer, and blue organic emission layer of the organic emission layer 720 may be respectively laminated on the red pixel, green pixel, and blue pixel, and a red color filter, a green color filter, and a blue color filter may be provided for the respective pixels, thereby displaying a color image. In another exemplary embodiment, a white organic emission layer for emitting white light may be disposed on all of the red, green, and blue pixels, and a red color filter, a green color filter, and a blue color filter may be provided for the respective pixels, thereby displaying a color image. When the white organic emission layer and the color filters are used to display a color image, there is no need to use a deposition mask for depositing the red, green, and blue organic emission layers on the respective pixels, i.e., the red, green, and blue pixels.

The white organic emission layer described in the illustrated exemplary embodiment may be provided as one organic emission layer or a plurality of organic emission layers that is laminated to emit white light. In an exemplary embodiment, at least one yellow organic emission layer and at least one blue organic emission layer may be combined to emit white light, at least one cyan organic emission layer and at least one red organic emission layer may be combined to emit white light, or at least one magenta organic emission layer and at least one green organic emission layer may be combined to emit white light.

A common electrode 730 is disposed on the pixel defining layer 350 and the organic emission layer 720. The common electrode 730 serves as a cathode of the OLED. The pixel electrode 710, the organic emission layer 720, and the common electrode 730 provide the OLED 70.

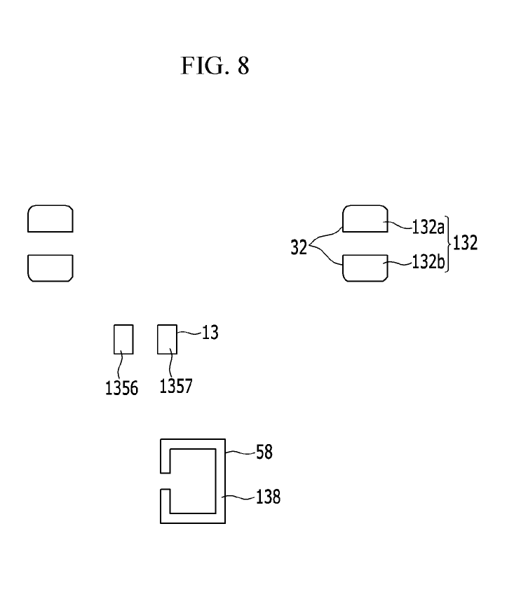

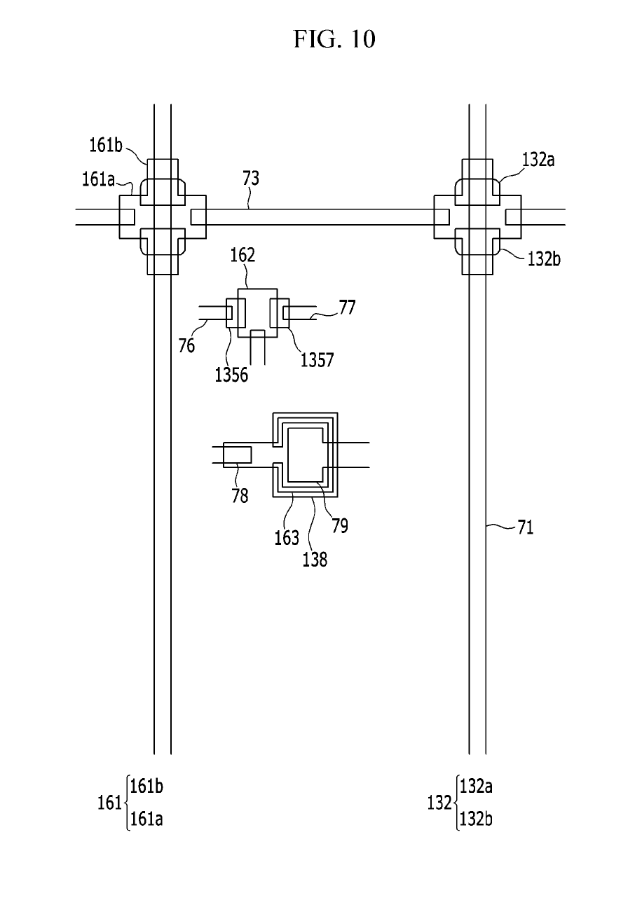

A manufacturing method of the OLED display according to an exemplary embodiment will now be described with reference to FIG. 8 to referring to FIG. 10 as well as FIGS. 2 to 7.

FIGS. 8 to 10 are plan views sequentially showing a manufacturing method of an OLED display according to an exemplary embodiment.

Firstly, as shown in FIG. 8, a buffer layer 120 is disposed on a substrate 110 (refers to FIGS. 3 to 7). The buffer layer 120 is deposited over the entire surface of the substrate 110 by a method such as plasma enhanced chemical vapor deposition (“PECVD”). Next, a semiconductor layer 130 is disposed on the buffer layer 120. The semiconductor layer 130 may include an intrinsic poly-semiconductor, and the intrinsic poly-semiconductor may be provided by a method of crystallizing an amorphous silicon layer after depositing the amorphous silicon layer. Also, a gate insulating layer 140 is disposed on the semiconductor layer 130 and a gate layer is disposed on the gate insulating layer 140. The gate insulating film 140 may include silicon nitride (SiNx) or silicon oxide (SiO2), and deposited over the entire surface of the buffer layer 120 by a method such as PECVD. The gate layer is patterned by using a mask through a photolithography process to define a gate opening 32, a transistor opening 13, and a storage opening 58. The semiconductor layer 130 exposed through the gate opening 32, the transistor opening 13 and the storage opening 58 is doped to provide a doped poly-semiconductor part including a crossing semiconductor part 132, transistor semiconductor parts 1356 and 1357, and a storage semiconductor part 138. A region where the doping is not performed among the semiconductor layer 130 corresponds to the intrinsic poly-semiconductor part 131.

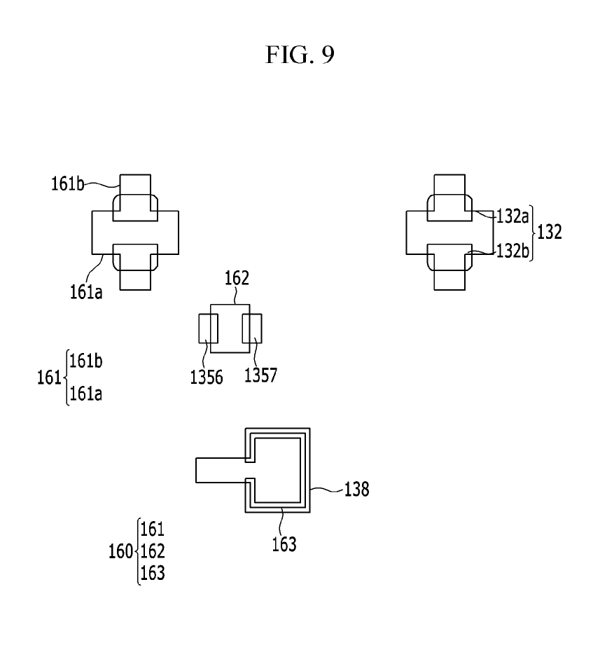

As shown in FIG. 9, the interlayer insulating layer pattern 160 including the crossing interlayer insulating layer pattern 161, the transistor interlayer insulating layer pattern 162, and the storage interlayer insulating layer pattern 163 is then disposed on the crossing semiconductor part 132, the transistor semiconductor parts 1356, and 1357, and the storage semiconductor part 138, respectively.

Next, as shown in FIG. 10, a data layer is disposed on the gate layer and the interlayer insulating layer pattern 160. The data layer is then patterned to provide the assistance scan line 73, the main data line 71, the main source electrode 76, the main drain electrode 77, the first assistance storage capacitive plate 78, and the second main storage capacitive plate 79.

As shown in FIGS. 2 to 7, the gate layer positioned near the assistance scan line 73, the main data line 71, the main source electrode 76, the main drain electrode 77, the first assistance storage capacitive plate 78 and the second main storage capacitive plate 79 is then patterned to expose the intrinsic poly-semiconductor part 131. At this time, the main scan line 51 is disposed under the assistance scan line 73 and the assistance data line 53 is disposed under the main data line 71. Also, the assistance source electrode 56 is disposed under the main source electrode 76, the assistance drain electrode 57 is disposed under the main drain electrode 77, the first main storage capacitive plate 58 is disposed under the first assistance storage capacitive plate 78, and the second assistance storage capacitive plate 59 is disposed under the second main storage capacitive plate 79.

The protective layer 180 covering the main data line 71, the assistance scan line 73, the main source electrode 76, the main drain electrode 77, the first assistance storage capacitive plate 78, and the second main storage capacitive plate 79 is then provided. The pixel electrode 710 is disposed on the protective layer 180, the pixel definition layer 350 is disposed on the protective layer 180 and the edge of the pixel electrode 710, and the organic emission layer 720 is provided in the opening 351 defined in the pixel definition layer 350. The common electrode 730 is disposed on the pixel definition layer 350 and the organic emission layer 720.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. An organic light emitting diode display comprising:
a substrate;
a semiconductor layer disposed on the substrate and including an intrinsic poly-semiconductor part and a doped poly-semiconductor part;
a gate insulating layer covering the semiconductor layer;
a scan line which is disposed on the gate insulating layer and transmits a scan signal;
a data line which is insulated from and intersects the scan line, and transmits a data signal;
a thin film transistor connected to the scan line and the data line; and
an organic light emitting diode connected to the thin film transistor,
wherein the intrinsic poly-semiconductor part is positioned at a region near the scan line.

2. The organic light emitting diode display of claim 1, wherein the scan line includes:
a main scan line disposed on the gate insulating layer, and
an assistance scan line disposed on the main scan line and contacting the main scan line.

3. The organic light emitting diode display of claim 2, wherein the data line includes:
an assistance data line disposed on the gate insulating layer, and
a main data line disposed on the assistance data line and contacting the assistance data line.

4. The organic light emitting diode display of claim 3, wherein
the doped poly-semiconductor part includes a crossing semiconductor part disposed at a crossing region of the scan line and the data line, and
the crossing semiconductor part includes a first crossing semiconductor part and a second crossing semiconductor part separated from and facing each other.

5. The organic light emitting diode display of claim 4, further comprising:
a crossing interlayer insulating layer pattern disposed on the crossing semiconductor part, and the main scan line,
wherein the crossing interlayer insulating layer pattern insulates the main scan line and the main data line from each other.

6. The organic light emitting diode display of claim 5, wherein
the crossing interlayer insulating layer pattern has a cross shape which includes a transverse part and a longitudinal part which are crossed,
the transverse part contacts the main scan line and is disposed thereon, and
the longitudinal part overlaps the crossing semiconductor part.

7. The organic light emitting diode display of claim 5, wherein:
separated portions of the assistance scan line are connected through the main scan line at the crossing region, and
separated portions of the assistance data line are connected through the main data line at the crossing region.

8. The organic light emitting diode display of claim 5, wherein
the intrinsic poly-semiconductor part is positioned under the main scan line and the assistance data line.

9. The organic light emitting diode display of claim 4, wherein
the doped poly-semiconductor part further includes a transistor semiconductor part disposed at the thin film transistor, and
the transistor semiconductor part includes a source region and a drain region separated from and facing each other.

10. The organic light emitting diode display of claim 9, further comprising:
a transistor interlayer insulating layer pattern partially overlapping the transistor semiconductor part; and
a source electrode and a drain electrode partially overlapping the transistor semiconductor part.

11. A method for manufacturing an organic light emitting diode display, the method comprising:
sequentially forming a semiconductor layer including an intrinsic poly-semiconductor, a gate insulating layer, and a gate layer on a substrate;
doping the semiconductor layer to provide a doped poly-semiconductor part and an intrinsic poly-semiconductor part;
forming an interlayer insulating layer pattern on the doped poly-semiconductor part and the gate layer;
forming a data layer on the gate layer and the interlayer insulating layer pattern;
patterning the data layer to provide an assistance scan line and a main data line; and
patterning the gate layer disposed at a region near the assistance scan line and the main data line to expose the intrinsic poly-semiconductor part.

12. The method of claim 11, wherein
the doped poly-semiconductor part includes a crossing semiconductor part disposed at a crossing region of the assistance scan line and the main data line.

13. The method of claim 12, wherein
the interlayer insulating layer pattern includes a crossing interlayer insulating layer pattern disposed at the crossing region.

14. The method of claim 12, wherein
the crossing semiconductor part and the intrinsic poly-semiconductor part are provided by patterning the gate layer to define a gate opening and doping the semiconductor layer through the gate opening.

15. The method of claim 11, wherein,
a main scan line is disposed under the assistance scan line and an assistance data line is disposed under the main data line.

16. The method of claim 15, further comprising,
forming a scan line including the main scan line and the assistance scan line and a data line including the main data line and the assistance data line, and connecting a thin film transistor to the scan line and the data line.

17. The method of claim 16, further comprising
forming an organic light emitting diode connected to the thin film transistor.
